(19) United States
(12) Patent Application Publication
(10) Pub. No.: US 2003/0079679 A1
(43) Pub. Date: May 1, 2003

(54) Spin coater

(76) Inventors: Toru Ikeda, Narita-shi (JP); Lily Pang, Fremont, CA (US)

Correspondence Address: APPLIED MATERIALS, INC., 2881 SCOTT BLVD. M/S 2061, SANTA CLARA, CA, 95050, US

(21) Appl. No.: 10/021,317

(22) Filed: Oct. 30, 2001

(51) Int. Cl. B05C 11/02; B05C 13/00

(52) U.S. Cl. 118/52

(57) ABSTRACT

Within a container b 2 of a spin coater 1, a rotatable support table 4 for supporting a wafer W and an arm 6 for dropping a chemical liquid onto the wafer W are arranged. Also, the spin coater 1 comprises a gas introducing path 12 for introducing a laminar flow forming gas into the container 2. The gas introducing path 12 has a glass filter 13 provided in an upper part of the container 2, whereas the laminar flow forming gas is introduced into the container 2 by way of the glass filter 13. The container 2 is provided with a wall portion 15 formed so as to continuously spread like a curve downward from a lower end edge part of the glass filter 13. As a consequence, a downflow of the laminar flow forming gas occurs in the whole horizontal section of the region surrounded by the wall portion 15 within the container 2, thereby reliably preventing turbulent flows from occurring.

### BACKGROUND OF THE INVENTION

1. Field of the Invention

The present invention relates to a spin coater for forming a thin film on a substrate by dropping a chemical liquid onto the substrate while rotating the substrate.

2. Related Background Art

For example, a spin coater has a container; a support table, disposed within the container, for supporting a wafer; driving means for rotating the support table; and chemical liquid dropping means for dropping a chemical liquid onto the wafer supported by the support table. For preventing turbulent flows from occurring due to the rotation of wafer, a laminar flow forming gas is usually introduced into the container in such a spin coater.

### SUMMARY OF THE INVENTION

However, the conventional technique mentioned above has not been able to prevent the turbulent flows from occurring in ceiling corner portions of the container since it has such a simple configuration that the laminar flow forming gas introduced from the ceiling of the container is discharged from an exhaust port in the lower part of the container. Therefore, it has been difficult to reduce the number of particles existing within the container.

It is an object of the present invention to provide a spin coater which can reliably prevent turbulent flows from occurring within the container.

The inventors conducted diligent studies and, as a result, have found that, while a filter for removing impurities from the laminar flow forming gas is provided in the upper part of the container, edge parts of the filter do not usually extend to the ceiling corner portions of the container, so that no downflow of the laminar flow forming gas occurs in the ceiling corner portions of the container, whereby turbulent flows occur in the ceiling corner portions of the container, thus accomplishing the present invention.

Namely, the spin coater of the present invention comprises a container; a support table, disposed within the container, for supporting a substrate; driving means for rotating the support table; chemical liquid dropping means for dropping a chemical liquid onto the substrate supported by the support table; and a filter, provided in an upper part of the container, for constituting a part of a gas introducing path for introducing a laminar flow forming gas into the container; wherein the container comprises a wall portion having a form extending downward from a lower end of the filter and continuously spreading downward.

When such a wall portion is provided in the container, a downflow of the laminar flow forming gas occurs in the whole horizontal section inside the wall portion within the container. Therefore, substantially no laminar flow forming gas flows back upward, whereby there is substantially no part generating a turbulent flow within the container. As a consequence, particles are prevented from rolling up when the support table supporting the substrate is rotated, whereby the number of particles existing within the container can be reduced.

Preferably, the wall portion is formed so as to continuously spread downward from a lower edge part of the filter. As a consequence, a downflow of the laminar flow forming gas sufficiently occurs within the container.

Preferably, the wall portion has a form continuously spreading downward like a curve. This yields a surface which is smooth to airflows, whereby the part generating turbulent flows within the container can be eliminated more reliably.

Preferably, the chemical liquid dropping means comprises an arm having a nozzle for letting out the chemical liquid onto the substrate supported by the support table; a pipe for supplying the chemical liquid to the nozzle; and a valve, connected to the pipe, for drawing therein the chemical liquid accumulated in a tip of the nozzle.

In another aspect, the spin coater of the present invention comprises a container; a support table, disposed within the container, for supporting a substrate; driving means for rotating the support table; chemical liquid dropping means for dropping a chemical liquid onto the substrate supported by the support table; a filter, provided in an upper part of the container, for constituting a part of a gas introducing path for introducing a laminar flow forming gas into the container; and a gas flow shaping member, provided under the filter so as to have an edge part extending downward from a lower end of the filter, for uniformly diffusing the laminar flow forming gas downward.

When such a gas flow shaping member is provided under the filter, a downflow of the laminar flow forming gas occurs in the whole horizontal section under the gas flow shaping member within the container. Therefore, substantially no laminar flow forming gas flows back upward, whereby there is substantially no part generating a turbulent flow within the container. As a consequence, particles are prevented from rolling up when the support table supporting the substrate is rotated, whereby the number of particles existing within the container can be reduced.

Preferably, the gas flow shaping member has a form having an edge part extending downward from a lower end edge part of the filter and continuously spreading downward. As a consequence, a downflow of the laminar flow forming gas sufficiently occurs within the container.

Preferably, the gas flow shaping member is a lattice-shaped guide member having a partition assembled like a lattice, whereas the lattice-shaped guide member has a part constructed so as to yield a partitioned area continuously increasing downward. This can realize the gas flow shaping member by a relatively simple configuration.

Preferably, in this case, the lattice-shaped guide member comprises an upper guide portion constructed so as to yield a partitioned area continuously increasing from an upper end to a lower end; and a lower guide portion disposed under the upper guide portion and constructed so as to yield a substantially uniform partitioned area from an upper end to a lower end. As a consequence, a downflow of the laminar flow forming gas effectively occurs in the whole horizontal section under the gas flow shaping member within the container.

Preferably, the chemical liquid dropping means comprises an arm having a nozzle for letting out the chemical liquid onto the substrate supported by the support table; a pipe for supplying the chemical liquid to the nozzle; and a valve, connected to the pipe, for drawing therein the chemical liquid accumulated in a tip of the nozzle.

### BRIEF DESCRIPTION OF THE DRAWINGS

FIG. 1 is a schematic diagram showing a first embodiment of the spin coater in accordance with the present invention;

FIG. 2 is a perspective view showing the container and gas introducing path shown in FIG. 1;

FIG. 3 is a simulation chart showing a state of airflows at the time when a laminar flow forming gas is introduced into the container;

FIG. 4 is a schematic diagram showing a second embodiment of the spin coater in accordance with the present invention; and

FIG. 5 is a perspective view showing the lattice-shaped guide member shown in FIG. 4.

### DESCRIPTION OF THE PREFERRED EMBODIMENTS

In the following, preferred embodiments of the spin coater in accordance with the present invention will be explained with reference to the drawings.

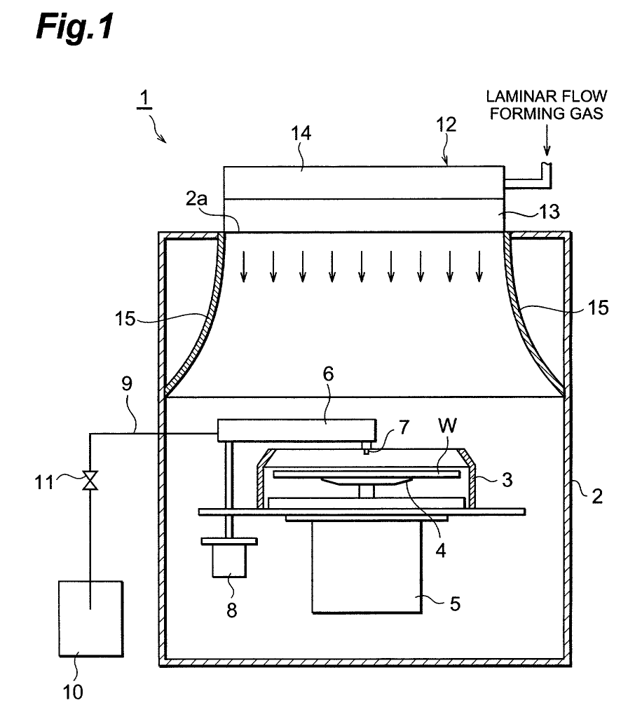

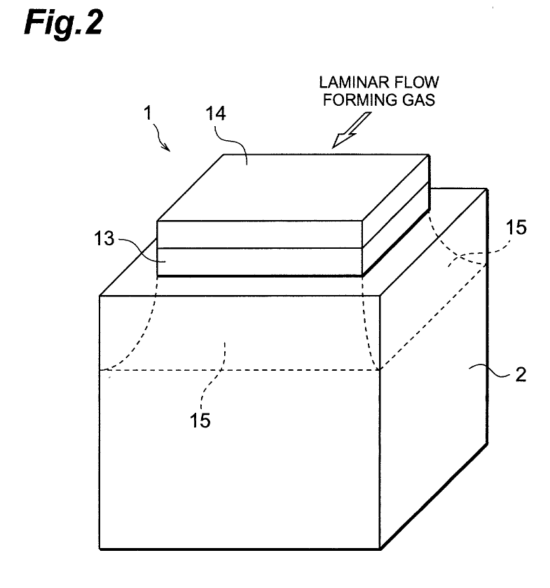

To begin with, a first embodiment of the present invention will be explained with reference to FIGS. 1 to 3. FIG. 1 is a schematic diagram showing the first embodiment of the spin coater in accordance with the present invention. In this drawing, the spin coater 1 of this embodiment comprises a container 2, which has a rectangular parallelepiped form with square upper and lower faces as shown in FIG. 2. The upper face of the container 2 is formed with a square opening 2a.

A cup 3 is accommodated within the container 2, whereas a support table 4 for supporting a wafer (substrate) W is arranged within the cup 3. The support table 4 is driven by a driving motor (driving means) 5 to rotate.

Also, within the container 2, an arm 6 for dropping a chemical liquid onto the wafer W supported by the support table 4 is arranged, whereas a front end part of the arm 6 is provided with a nozzle 7 for letting out the chemical liquid. The arm 6 is horizontally rotatable by the driving motor 8. A chemical liquid tank 10 is connected to the nozzle 7 by way of a pipe 9, whereby the chemical liquid stored in the chemical liquid tank 10 is supplied to the nozzle 7 by way of the pipe 9. A valve 11 for drawing therein the chemical liquid accumulated in the front end of the nozzle 7 is connected to the pipe 9. Here, the arm 6, pipe 9, chemical liquid tank 10, and valve 11 constitute chemical liquid dropping means for dropping the chemical liquid onto the wafer W supported by the support table 4.

When forming a thin film (e.g., SiO₂ film) on the wafer W supported by the support table 4 in such a spin coater 1, a fluorine-doped glass solvent, for example, is used as the chemical liquid. Then, for example, while the arm 6 is moved such that the nozzle 7 is positioned at the center of the wafer W, the support table 4 is rotated. When the chemical liquid is gushed out toward the center of the wafer W from the nozzle 7 in this state, it spreads about the rotating wafer W, thereby forming a substantially uniform thin film over the surface of the wafer W.

In order to prevent turbulent flows from occurring due to the rotation of the wafer W at the time of forming a film as mentioned above, the spin coater 1 further comprises a gas introducing path 12 for introducing a laminar flow forming gas into the container 2. The gas introducing path 12 comprises a square glass filter 13 provided at the position of the opening 2a in the upper part of the container 2; and a gas filling chamber 14, disposed on the upper side of the glass filter 13, for receiving the laminar flow forming gas. The laminar flow forming gas within the gas filling chamber 14 is introduced into the container 2 by way of the glass filter 13. At that time, impurities contained in the laminar flow forming gas are eliminated in the glass filter 13. Then, the laminar flow forming gas flows downward within the container 2, so as to be discharged from an exhaust port (not depicted)

The container 2 is also provided with a wall portion 15 formed so as to continuously spread downward like a curve from the rim part of the opening 2a, i.e., the lower end edge part of the glass filter 13. As a consequence, the laminar flow forming gas having passed the vicinity of the edge part of the glass filter 13 flows downward along the wall portion 15. Since the wall portion 15 is formed so as to spread like a curve, a face which is smooth to flows of the laminar flow forming gas is obtained.

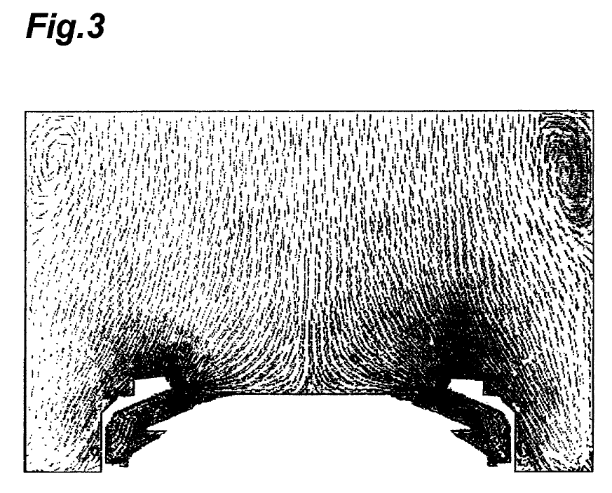

FIG. 3 shows a simulation chart of airflows obtained when the laminar flow forming gas is introduced into the container 2 in the state where the support table 4 is not rotated in a configuration in which the container 2 is not provided with the above-mentioned wall portion 15. As can be seen from this chart, whirl-like turbulent flows are generated in ceiling corner portions of the container 2. The following is considered to be a cause for generating such turbulent flows.

Namely, since the length of one side of the glass filter 13 is shorter than the length of one side of the upper face of the container 2, the configuration must be such that the edge part of the glass filter 13 does not extend to corner portions of the container 2. As a consequence, no downflow of the laminar flow forming gas occurs in the region outside the glass filter 13 in the upper part within the container 2. Therefore, a part of the laminar flow forming gas flowing downward within the container 2 collides with the cup 3 and flows toward ceiling corner portions of the container 2, for example, without being discharged from the exhaust port (not depicted). As a result, whirl-like turbulent flows such as those shown in FIG. 3 occur at ceiling corner portions of the container 2. When the support table 4 supporting the wafer W is rotated in a case where such a turbulent flow exists, particles existing within the container 2 roll up, thus making it difficult to reduce the number of particles within the container 2.

In this embodiment, by contrast, the container 2 is provided with the wall portion 15 continuously spreading downward from the lower end edge part of the glass filter 13, whereby a substantially uniform downflow of the laminar flow forming gas is obtained in the whole horizontal section in the region surrounded by the wall portion 15 within the container 2. As a consequence, no laminar flow forming gas collides with the cup 3 and flows back upward, for example, whereby there is no part generating turbulent flows within the container 2. This prevents particles from rolling up when the support table 4 is rotated, whereby the number of particles existing within the container 2 can be reduced.

Here, the state of turbulent flows occurring at ceiling corner portions of the container 2 can be defined from results of a simulation, whereby the roll-up of particles can reliably be reduced when the form of the wall portion 15 is defined so as to eliminate the turbulent flows.

Though the wall portion 15 of the container 2 is formed so as to continuously spread downward from the lower end edge part of the glass filter 13 in this embodiment, the structure of wall portion is not limited thereto in particular as long as it is configured so as to have a form extending downward from the lower end of the glass filter 13 and continuously spreading downward. Here, the wall portion may have a linearly-spreading form. Since the upper part of the container 2 is provided with the wall portion 15, it is not necessary for the container 2 to have a part outside the wall portion 15 in particular.

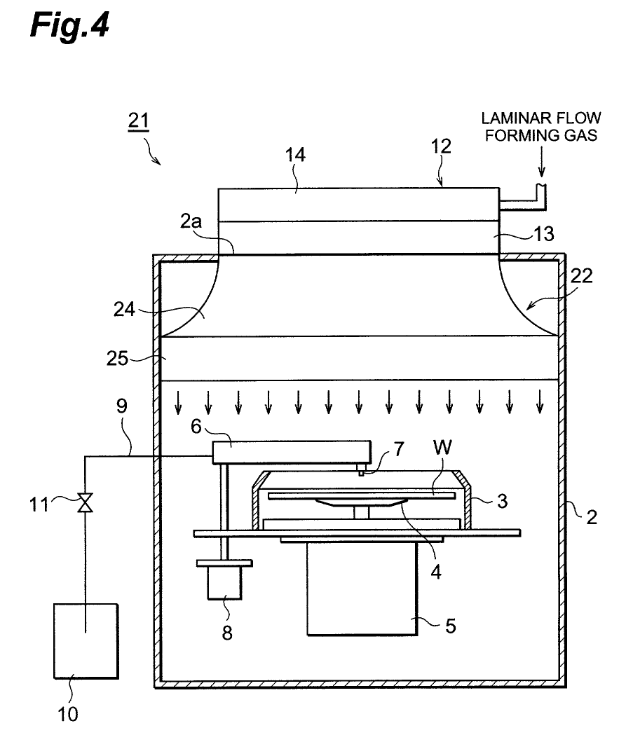

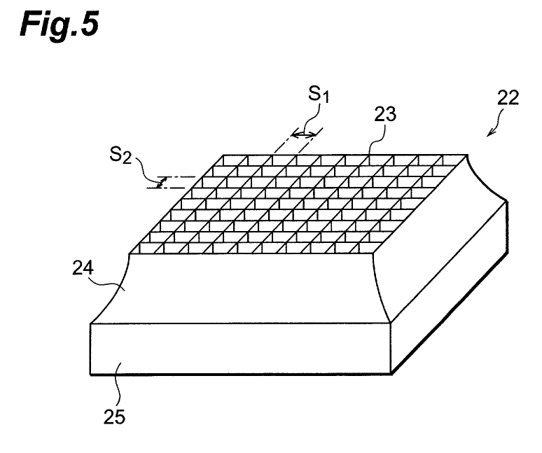

A second embodiment of the present invention will be explained with reference to FIGS. 4 and 5. In the drawings, members identical or equivalent to those of the first embodiment will be referred to with numerals identical thereto without repeating their explanations.

FIG. 4 is a schematic diagram showing the second embodiment of the spin coater in accordance with the present invention. In this drawing, the spin coater 21 of this embodiment comprises a lattice-shaped guide member 22 which is a gas flow shaping member provided under the glass filter 13 within the container 2, whereas edge parts of the lattice-shaped guide member 22 extend downward from the lower end edge part of the glass filter 13. The lattice-shaped guide member 22 has partitions 23 assembled like a lattice (see FIG. 5), thereby uniformly diffusing the laminar flow forming gas downward. The number of partitions 23 is unchanged between the upper and lower ends of the lattice-shaped guide member 22 as a matter of course.

Preferably, the lattice-shaped guide member 22 is constituted by an upper guide portion 24 having an edge part formed so as to continuously spread like a curve from the lower end edge part of the glass filter 13 and a lower guide portion 25 provided under the upper guide portion 24. The upper guide portion 24 is configured such that its partitioned area (S₁×S₂ in FIG. 5) continuously increases from the upper end to lower end thereof. The lower guide portion 25 is configured such that its partitioned area is substantially uniform from the upper end to lower end thereof.

When such a lattice-shaped guide member 22 is provided, the laminar flow forming gas introduced into the container 2 by way of the glass filter 13 spreads uniformly, whereby a substantially uniform downflow of the laminar flow forming gas is obtained in the whole horizontal section under the lattice-shaped guide member 22. Therefore, there is no part generating turbulent flows within the container 2 as mentioned above, so that the particles are prevented from rolling up when the support table 4 is rotated, whereby the number of particles. existing within the container 2 can be reduced.

Though the lattice-shaped guide member 22 is used as a member for shaping the flow of the laminar flow forming gas so as to make it uniformly spread downward in this embodiment, not only the above-mentioned lattice-shaped guide member but also a filter made of a mesh, cotton, and the like may be used as such a gas flow shaping member.

What is claimed is:

1. A spin coater comprising:
a container;
a support table, disposed within said container, for supporting a substrate;
driving means for rotating said support table;
chemical liquid dropping means for dropping a chemical liquid onto said substrate supported by said support table; and
a filter, provided in an upper part of said container, for constituting a part of a gas introducing path for introducing a laminar flow forming gas into said container;
wherein said container comprises a wall portion having a form extending downward from a lower end of said filter and continuously spreading downward.

2. A spin coater according to claim 1, wherein said wall portion is formed so as to continuously spread downward from a lower end edge part of said filter.

3. A spin coater according to claim 1, wherein said wall portion has a form continuously spreading like a curve downward.

4. A spin coater according to claim 1, wherein said chemical liquid dropping means comprises an arm having a nozzle for letting out said chemical liquid onto said substrate supported by said support table; a pipe for supplying said chemical liquid to said nozzle; and a valve, connected to said pipe, for drawing therein said chemical liquid accumulated in a tip of said nozzle.

5. A spin coater comprising:
a container;
a support table, disposed within said container, for supporting a substrate;
driving means for rotating said support table;
chemical liquid dropping means for dropping a chemical liquid onto said substrate supported by said support table;
a filter, provided in an upper part of said container, for constituting a part of a gas introducing path for introducing a laminar flow forming gas into said container; and
a gas flow shaping member, provided under said filter so as to have an edge part extending downward from a lower end of said filter, for uniformly diffusing said laminar flow forming gas downward.

6. A spin coater according to claim 5, wherein said gas flow shaping member has a form having an edge part extending downward from a lower end edge part of said filter and continuously spreading downward.

7. A spin coater according to claim 5, wherein said gas flow shaping member is a lattice-shaped guide member having a partition assembled like a lattice,
said lattice-shaped guide member having a part constructed so as to yield a partitioned area continuously increasing downward.

8. A spin coater according to claim 7, wherein said lattice-shaped guide member comprises an upper guide portion constructed so as to yield a partitioned area continuously increasing from an upper end to a lower end; and a lower guide portion disposed under said upper guide portion and constructed so as to yield a substantially uniform partitioned area from an upper end to a lower end.

9. A spin coater according to claim 5, wherein said chemical liquid dropping means comprises an arm having a nozzle for letting out said chemical liquid onto said substrate supported by said support table; a pipe for supplying said chemical liquid to said nozzle; and a valve, connected to said pipe, for drawing therein said chemical liquid accumulated in a tip of said nozzle.
